(19) United States
(12) Patent Application Publication
(10) Pub. No.: US 2010/0266877 A1
(43) Pub. Date: Oct. 21, 2010

(54) BATTERY PACK AND BATTERY PACK MANUFACTURING METHOD

(76) Inventors: Hideaki EBIHARA, Osaka (JP); Tatsuya KAMADA, Osaka (JP)

Correspondence Address: BIRCH STEWART KOLASCH & BIRCH, PO BOX 747, FALLS CHURCH, VA, 22040-0747, US

(21) Appl. No.: 12/763,370

(22) Filed: Apr. 20, 2010

(30) Foreign Application Priority Data
Apr. 21, 2009 (JP) 2009-103233

(51) Int. Cl. H01M 14/00; H01M 2/02; H01M 10/00

(52) U.S. Cl. 429/7; 429/178; 29/623.1

(57) ABSTRACT

In a battery pack in which a protective circuit is fitted to a unit cell and accommodated in an exterior cover, a frame is provided in the exterior cover, the frame being fixed to the unit cell and supporting the protective circuit, where a protruding portion protruded from the frame and an engaging hole provided in the unit cell are engaged with each other. As a result of this, when external force acts on the exterior cover, movement of the frame integrated with the exterior cover can be inhibited.

### BACKGROUND OF THE INVENTION

1. Field of the Invention

The present invention relates to a battery pack, as well as a manufacturing method therefor, in which accessory parts for extracting electricity from a terminal portion of a unit cell are covered with an exterior member.

2. Description of Related Art

With the trend toward thinner and smaller battery packs in recent years, there is a current tendency that, as the mainstream of battery packs, a positive lead and a negative lead are taken from the sealing side of a unit cell upper part so as to provide an exterior part in which accessory parts such as a protective circuit and protective elements are integrated in upper part of the unit cell.

FIG. 14 shows an exploded perspective view of an example of a conventional battery pack. The battery pack 120 shown in FIG. 14, which is an example of an integrally molded structure that the exterior part is covered with a resin mold, has a thinned flat quadrilateral shape whose depth is smaller in comparison to its longitudinal height and lateral length. One end of a lead (electrode lead) 123 is welded to a positive terminal 122 of a unit cell 121, while one end of a lead 125 is welded to a negative terminal 124. The other end of the lead 123 is welded to a protective circuit 126, while the other end of the lead 125 is welded to one end of a protective element 127. The other end of the protective element 127 is welded to one end of a lead 128, while the other end of the lead 128 is welded to the protective circuit 126. Between the protective circuit 126 and the unit cell 121 is interposed an insulating plate 130.

By injection of resin to between the unit cell 121 and an exterior cover 129, various components of the upper part of the unit cell 121, the exterior cover 129 and the resin are integrally molded. In FIG. 14, the integrally molded resin 131 is depicted in separation for an easier depiction. In a completed state of the battery pack 120, the integrally molded resin 131 is interposed between the upper part of the unit cell 121 and the exterior cover 129 so as to be integrated together with them.

A case bottom cover 132 is stuck to a lower portion of the unit cell 121 via a double-sided tape 133. A label 134 is stuck all around the unit cell 121.

FIG. 15 shows a main-part perspective view of a state that the component members of the battery pack of FIG. 14 are assembled together. In the structure of FIG. 14, the protective circuit and the protective elements are integrated in the upper part of the unit cell 121, making it possible to realize a thinner and smaller battery pack in the completed state as shown in FIG. 15.

In the structure of FIG. 15, on the other hand, the unit cell 121 and the integrally molded resin 131 are separate structural bodies. Also, as the resin to be injected to between the unit cell 121 and the exterior cover 129, a relatively soft resin material (e.g., polyamide resin) is used in consideration of chargeability to that narrow portion or the like. The unit cell 121, which is formed from a metal material (aluminum or aluminum alloy etc.), is basically not joined to such a resin material.

Therefore, as shown in FIG. 15, when an external force causes a torsion, i.e. twist T or bend M, to act on the integrally molded resin 131, the force acts so that the integrally molded resin 131 is separated from the unit cell 121. In this case, when an increased external force is applied, there could occur deformation or fracture of the exterior part.

Particularly in recent years, it has more often been becoming the case that such battery packs to be used in portable electronic equipment or the like are carried in one battery pack alone as an auxiliary battery pack in addition to a battery pack mounted on the portable electronic equipment main unit. In such a case where the battery pack is carried by itself alone, unforeseen external force may be applied to the battery pack. Thus, there is a desire for improving the mechanical strength of the battery pack alone.

In order to solve these and other problems, various structures are proposed. For example, Documents 1 and 2 below show proposals for screwing a cover portion to the unit cell. Documents 3 to 5 below propose structures in which resin mold is integrally molded with the unit cell, where a protruding portion is embedded into the resin mold. Documents 6 and 7 propose that connecting components are interposed between the cover portion and the unit cell to bind the two members together.

Document 1: JP 2008-112725 A

Document 2: JP 2006-164531 A

Document 3: JP 2007-165328 A

Document 4: JP 2003-282039 A

Document 5: JP 2005-129528 A

Document 6: JP 2006-236735 A

Document 7: JP 2004-319144 A

### SUMMARY OF THE INVENTION

However, in the structures proposed in the Documents shown above, although the binding power between exterior part and unit cell can be enhanced, there arises a need for adding new component members such as screws, a protruding portion and connecting components while the structure becomes more complex.

The present invention having been accomplished to solve the above-described issues, an object of the invention is to provide a battery pack which can secure the reliability of mechanical strength of the exterior part with a simple structure.

In order to achieve the above object, the present invention has the following constitutions.

According to a first aspect of the present invention, there is provided a battery pack comprising:

a unit cell having a mounting surface on which a terminal portion is formed;

accessory parts for extracting electricity from the terminal portion of the unit cell to outside of the battery pack; and

an exterior member which covers the mounting surface of the unit cell and the accessory parts, wherein

the accessory parts include a frame for holding the exterior member, and

either one of an engaging hole and a protruding portion, which are to be engaged with each other, is formed on the mounting surface of the unit cell while the other of the engaging hole and the protruding portion is formed in the frame, so that the frame is fixed to the mounting surface at least in a direction along the mounting surface of the unit cell.

According to a second aspect of the invention, there is provided a battery pack comprising:

a unit cell having a mounting surface on which a terminal portion is formed;

accessory parts for extracting electricity from the terminal portion of the unit cell to outside of the battery pack; and

an exterior member which covers the mounting surface of the unit cell and the accessory parts, wherein

either one of an engaging hole and a protruding portion, which are to be engaged with each other, is formed on the mounting surface of the unit cell while the other of the engaging hole and the protruding portion is formed in the frame, so that the frame is fixed to the mounting surface at least in a direction along the mounting surface of the unit cell.

According to a third aspect of the invention, there is provided a battery pack manufacturing method comprising:

making an engaging hole and a protruding portion engaged with each other to fulfill positioning of a frame relative to a mounting surface of a unit cell in which at least one of the engaging hole and the protruding portion is formed, the frame having the other of the engaging hole and the protruding portion formed therein, as well as to fulfill positioning of a terminal portion formed in the mounting surface within an opening of the frame;

setting a strip-shaped electrical-connection use lead so that inner peripheral surfaces of the opening of the frame and widthwise end faces of the lead are put into contact with each other, whereby the lead is placed on the terminal portion exposed from the opening;

welding the lead and the terminal portion together so that at an engagement place between the frame and the lead, the frame is fixed at least in a widthwise direction of the strip-shaped lead; and

thereafter fitting an exterior member to the frame so as to cover the terminal portion, the lead and the frame so that the exterior member is fixed to the mounting surface at least in a direction along the mounting surface.

According to the present invention, in the battery pack, the reliability of mechanical strength of the exterior part can be secured with a simple structure.

### BRIEF DESCRIPTION OF THE DRAWINGS

These aspects and features of the present invention will become clear from the following description taken in conjunction with the preferred embodiments thereof with reference to the accompanying drawings, in which:

FIG. 1 is an exploded perspective view of a battery pack according to Embodiment 1 of the present invention;

FIG. 2A is a perspective view showing a state of the battery pack according to Embodiment 1 immediately before mounting of a lead and a frame;

FIG. 2B is a perspective view showing a state of the battery pack according to Embodiment 1 immediately before welding of a protective element;

FIG. 3A is a perspective view showing a state of the battery pack according to Embodiment 1 immediately before mounting of a protective circuit;

FIG. 3B is a perspective view showing a state of the battery pack according to Embodiment 1 in which the protective circuit has been mounted;

FIG. 4A is a perspective view of the battery pack according to Embodiment 1 immediately before mounting of an exterior cover;

FIG. 4B is a perspective view of a state of the battery pack according to Embodiment 1 in which the exterior cover has been mounted;

FIG. 5 is a perspective view showing a state in which the battery pack according to Embodiment 1 has been completed;

FIG. 6A is a sectional view of the battery pack taken along the line A-A of FIG. 3B;

FIG. 6B is a sectional view of the battery pack taken along the line C-C of FIG. 3B;

FIG. 6C is a sectional view of the battery pack taken along the line B-B of FIG. 3B;

FIG. 7 is an exploded perspective view of a battery pack according to Embodiment 2 of the invention;

FIG. 8 is a perspective view of the battery pack according to Embodiment 2;

FIG. 9 is an enlarged view of an upper part of the unit cell before setting of the exterior cover in FIG. 7;

FIG. 10 is a perspective view showing a state that a negative lead and a positive lead are welded to the unit cell in FIG. 7;

FIG. 11A is a sectional view of the battery pack taken along the line D-D of FIG. 10;

FIG. 11B is a sectional view of the battery pack taken along the line E-E of FIG. 10;

FIG. 11C is a sectional view of the battery pack taken along the line F-F of FIG. 10;

FIG. 12 is a perspective view showing a frame, the negative lead and the positive lead;

FIG. 13 is a perspective view showing an insert-molded frame according to Embodiment 2;

FIG. 14 is an exploded perspective view of an example of a conventional battery pack; and

FIG. 15 is a perspective view of a main part of a state in which individual components of the conventional battery pack of FIG. 14 are assembled together.

### DETAILED DESCRIPTION OF THE PREFERRED EMBODIMENTS

According to the battery pack of the invention, either one of an engaging hole and a protruding portion, which are to be fitted to each other, is formed in a mounting surface (terminal formation surface) of the unit cell, while the other of the engaging hole and the protruding portion is formed in the frame, where the frame is fixed at least in a direction along the mounting surface of the unit cell. With this constitution, movement of the frame caused by any external force acting on the exterior member held by the frame can be suppressed, so that the reliability of mechanical strength of the exterior part (exterior member and accessory parts) can be secured with a simple structure.

Preferably, in the battery pack of the invention, the accessory parts include a strip-shaped electrical-connection use lead which is connected to the terminal portion of the unit cell by welding so that the terminal portion and the protective circuit are electrically connected to each other, and the lead and the frame are engaged with each other. With this constitution, by the engagement between the lead and the frame as well as the engagement between the engaging hole and the protruding portion, the mechanical strength of the exterior part can be improved, there is provided a further advantage in securing the reliability of the mechanical strength.

Preferably, in the battery pack, an opening through which the lead is set is formed in the frame, and with mutually opposed first inner peripheral surfaces of the opening of the frame serving as the engagement portion, widthwise both end faces of the strip-shaped lead are set into contact with the first inner peripheral surfaces, whereby the frame is engaged with the lead in a widthwise direction of the lead. With this constitution, not only the mechanical strength against external force applied in the direction along the mounting surface can be enhanced by the engagement between the engaging hole and the protruding portion, but also the mechanical strength against external force applied in the widthwise direction of the lead can be enhanced. Thus, the frame can be prevented from moving upon action of torsion.

Preferably, second inner peripheral surface crossing with the first inner peripheral surfaces of the opening of the frame is used as further said engagement portion, and longitudinal end face of the strip-shaped lead is set into contact with the second inner peripheral surface, whereby the frame is engaged with the lead in the longitudinal direction of the lead. With this constitution, the mechanical strength against external force applied in the longitudinal direction as well as in the widthwise direction of the lead can be enhanced. Thus, the frame can be further prevented from moving particularly upon action of torsion.

Preferably, protruding portions inwardly protruded from the mutually opposed first inner peripheral surfaces of the opening of the frame are formed as further said engagement portion, and a unit cell-side surface of the strip-shaped lead is set into contact with the protruding portions, whereby the frame is engaged with the lead in a thicknesswise direction of the lead. With this constitution, the mechanical strength against external force applied in the thicknesswise direction of the lead can be enhanced, so that the frame can be prevented from moving particularly upon action of torsion. Further, the mechanical strength for both torsion and bend can be improved by combining together the engagement of the lead in the widthwise and longitudinal directions and the engagement in this thicknesswise direction.

Preferably, at welding-connecting portions between the lead and the terminal portion of the unit cell, the unit cell-side surface of the lead, formed so as to have a larger size in a widthwise direction of the strip-shaped lead than the terminal portion of the unit cell and protruded in the widthwise direction from the terminal portion, is engaged with the protruding portions.

Preferably, the unit cell has a flat quadrilateral shape whose depth is smaller in comparison to its longitudinal height and lateral length, and exterior members and accessory parts are mounted on a mounting surface which is given by a longitudinal end face of the unit cell, where the widthwise direction of the strip-shaped lead corresponds to a depthwise direction of the unit cell and the thicknesswise direction of the lead corresponds to a longitudinal direction of the unit cell. Thus, the effect of improving the mechanical strength of the exterior part can be produced more effectively.

Preferably, a terminal portion is provided at one of lateral both end portions of the mounting surface of the unit cell, and an engaging hole or a protruding portion is provided in the other one of the end portions. With such a constitution, the mechanical strength against a bend that acts chiefly in the depthwise direction of the thinned unit cell can be improved.

Preferably, the protruding portion is press fitted into the engaging hole. With this constitution, when a bend acts to cause the exterior member to be floated from the unit cell, there is provided an advantage for preventing displacement of the frame integrated with the exterior member.

Preferably, the engaging hole and the protruding portion to be engaged with each other are provided in a plurality of sets. With this constitution, there is provided a further advantage in securing the reliability of the mechanical strength.

According to the battery pack manufacturing method of the invention, the method comprising the steps of: making an engaging hole and a protruding portion engaged with each other to fulfill positioning of a frame relative to a mounting surface of a unit cell in which at least one of the engaging hole and the protruding portion is formed, the frame having the other of the engaging hole and the protruding portion formed therein, as well as to fulfill positioning of a terminal portion formed in the mounting surface within an opening of the frame; setting a strip-shaped electrical-connection use lead so that inner peripheral surfaces of the opening of the frame and widthwise end faces of the lead are put into contact with each other, whereby the lead is placed on the terminal portion exposed from the opening; welding the lead and the terminal portion together so that at an engagement place between the frame and the lead, the frame is fixed at least in a widthwise direction of the strip-shaped lead; and thereafter fitting an exterior member to the frame so as to cover the terminal portion, the lead and the frame so that the exterior member is fixed to the mounting surface at least in a direction along the mounting surface. With such a method, making the engaging hole and the protruding portion engaged with each other allows the positioning of the lead relative to the terminal portion can be easily achieved by using the frame. Further, welding the lead to the terminal portion makes it possible to enhance the mechanical strength of the frame or the like against external force applied at least in the widthwise direction of the lead at the engagement place between the frame and the lead. Moreover, the mechanical strength can be enhanced at least in the direction along the mounting surface by the engagement between the engaging hole and the protruding portion. Thus, a battery pack which allows the frame to be prevented from moving particularly upon action of torsion can be manufactured at high productivity.

Also, by making the frame engaged also in the lead tape of the lead, the mechanical strength of the frame or the like against external force applied in the longitudinal direction can be enhanced. Thus, the frame can be prevented from moving upon action of torsion more effectively.

Also, by making the frame engaged also in the thicknesswise direction of the lead, the mechanical strength of the frame or the like against external force applied in the thicknesswise direction can be enhanced. Thus, the frame can be prevented from moving upon action of bend as well as torsion.

Before the description of the present invention proceeds, it is to be noted that like parts are designated by like reference numerals throughout the accompanying drawings.

Hereinbelow, embodiments of the present invention will be described in detail with reference to the accompanying drawings.

### First Embodiment

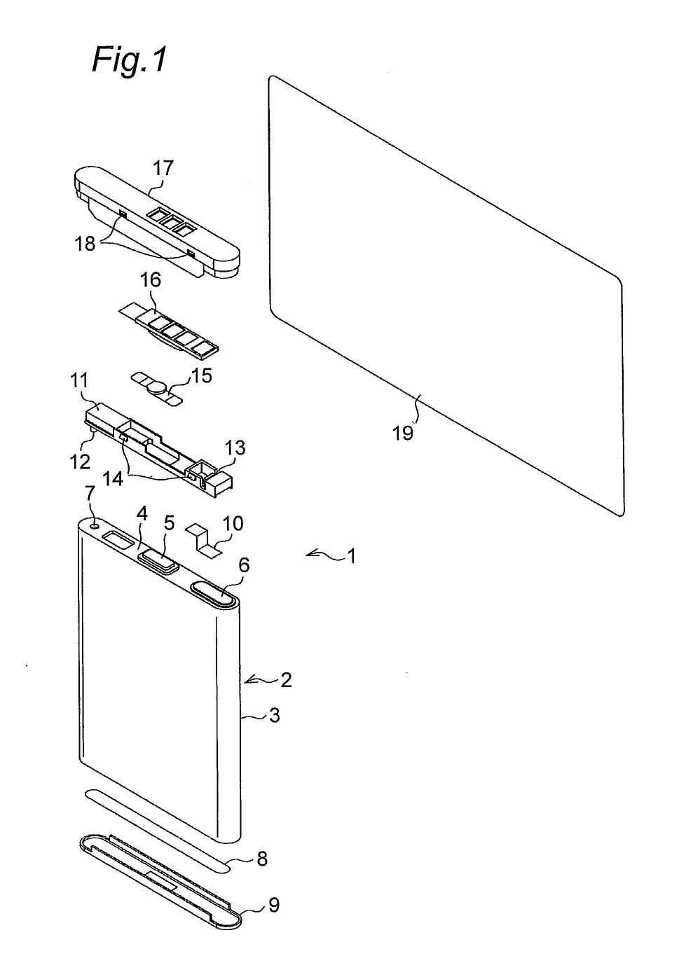

FIG. 1 is an exploded perspective view of a battery pack according to Embodiment 1 of the invention. First, an outlined constitution of the battery pack is described with reference to FIG. 1. FIG. 1 shows a battery pack 1 and various accessory parts to be fitted thereto. A unit cell 2 is so made up that power generation elements are contained in a smaller-in-thickness, rectangular-shaped exterior case 3 formed from aluminum or aluminum alloy as an example. The unit cell 2 is a rectangular-shaped lithium ion battery, as an example, which is used in mobile phones, mobile equipment or the like. It is noted that the term “accessory parts” refers to various types of component parts for extracting electricity from the unit cell 2 to outside of the battery pack 1. Also, the battery pack 1 has a thinned flat quadrilateral shape whose depth is smaller in comparison to its longitudinal height and lateral length.

An opening portion of the exterior case 3 is sealed by a sealing member 4. The sealing member 4 is provided with a negative terminal 5 and a positive terminal 6. A case bottom cover 9 is fitted to the sealing member 4 via double-sided tape 8. A resin-made frame 11 is fitted to the sealing member 4 in upper part of the unit cell 2. That is, an upper portion (upper end face) of the unit cell 2 in the figure serves as a mounting surface (terminal formation surface) on which the negative terminal 5 and the positive terminal 6 are formed.

As will be described in detail later, a protruding portion 12 formed in the frame 11 is engaged with an engaging hole 7 formed in the sealing member 4 in a state that the frame 11 is fitted to the sealing member 4. Further, a lead 10 for electrical connection use is engaged with the frame 11 while inserted through an opening 13 formed in the frame 11.

One end of a protective element 15 is bonded to the negative terminal 5 of the unit cell 2 by welding, and one end of the lead 10 is bonded to the positive terminal 6 of the unit cell 2 by welding. The frame 11 supports a protective circuit 16, and the protective circuit 16 is bonded by welding to the lead 10, through which the opening formed in the frame 11 has been inserted. The protective element 15 and the protective circuit 16 are protection means for preventing overcharge, overcurrents, overdischarge and the like. Material of the lead 10 may be decided in accordance with the material of the positive terminal 6, examples of the material including nickel, iron, stainless steel and the like. The lead 10 is formed as a strip-shaped member.

Holes 18 of an exterior cover 17 (exterior member), which is a resin molded article, and fixing claws of the frame 11 are engaged with each other, respectively, by which the exterior cover 17 is fixed (i.e. held) to the frame 11. A label 19 is stuck all around the unit cell 2. In addition, the frame 11 has electric insulation property as an example. Also, from a viewpoint that the exterior cover 17 is supported by the frame 11, preferably, the frame 11 is made from a resin material having such rigidity as to withstand external force such as torsion and bend. Materials for forming the frame 11 include polycarbonate. In addition, in Embodiment 1, the frame 11, the protective circuit 16, the protective element 15, the external-connection use terminals, the lead 10 and the like are included in the accessory parts.

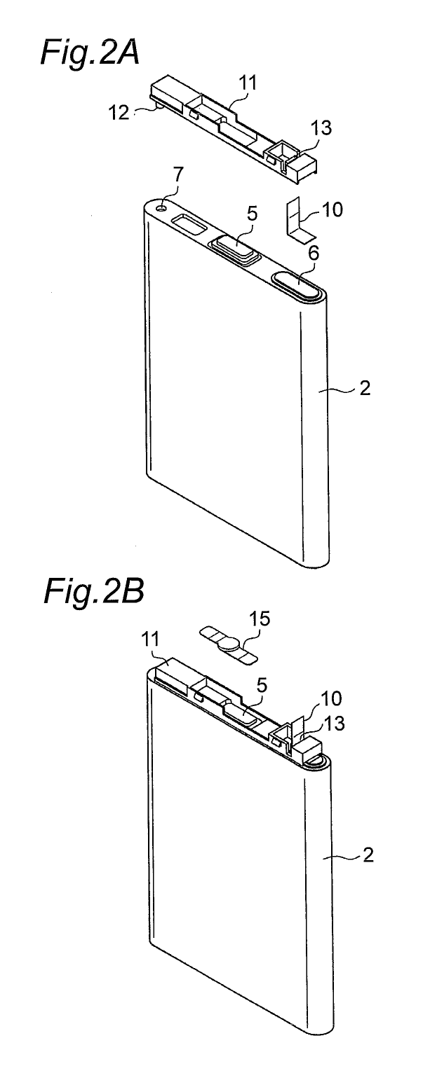

FIGS. 2A, 3A, 3B, 4A, 4B and 5 show the battery pack 1 according to Embodiment 1 in an order of its manufacturing process.

First, FIG. 2A is a perspective view showing a state immediately before mounting of the lead 10 and the frame 11. One end of the lead 10 is welded to the positive terminal 6 of the unit cell 2. Thereafter, the protruding portion 12 formed in the frame 11 is engaged with the engaging hole 7 formed in the sealing member 4.

As shown in FIG. 2A, instead of the case that the frame 11 is mounted after one end of the lead 10 is welded to the positive terminal 6 of the unit cell 2, one end of the lead 10 may be welded to the positive terminal 6 after the frame 11 is positioned relative to the positive terminal 6 by making the protruding portion 12 of the frame 11 engaged with the engaging hole 7 of the sealing member 4. In this case, the frame 11 is desirably formed into such a shape that the positive terminal 6 and the lead 10 can be welded together from the upper surface side of the frame 11.

FIG. 2B is a perspective view showing a state immediately before welding of the protective element 15. One end of the protective element 15 is welded to the negative terminal 5 exposed to the opening of the frame 11.

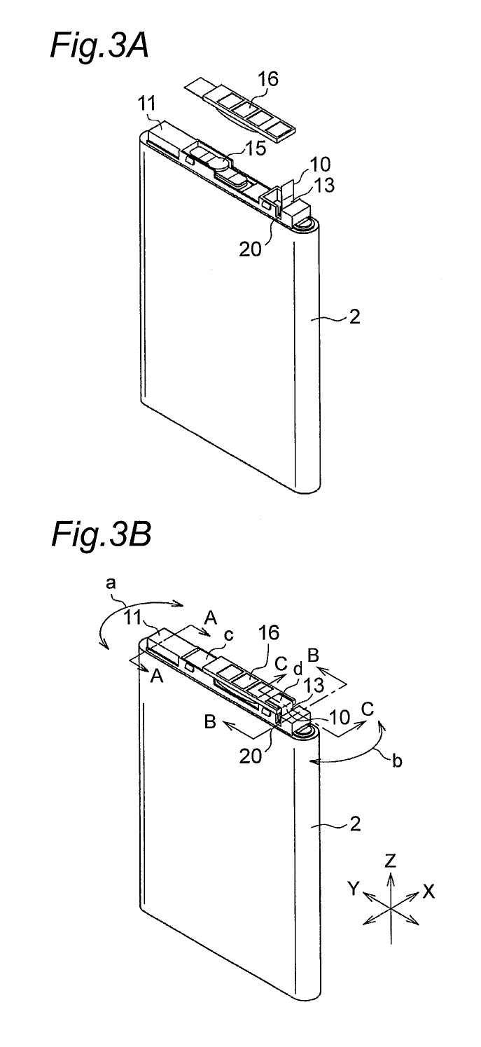

FIG. 3A is a perspective view showing a state immediately before mounting of the protective circuit 16. FIG. 3B is a perspective view of a state in which the protective circuit 16 has been mounted. After the protective circuit 16 is set on the frame 11, the lead 10 is bent toward the protective circuit 16. In this state, one end of the protective element 15 and one end of the protective circuit 16 are welded together (c portion in FIG. 3B), and one end of the lead 10 and the other end of the protective circuit 16 are welded together (d portion in FIG. 3B).

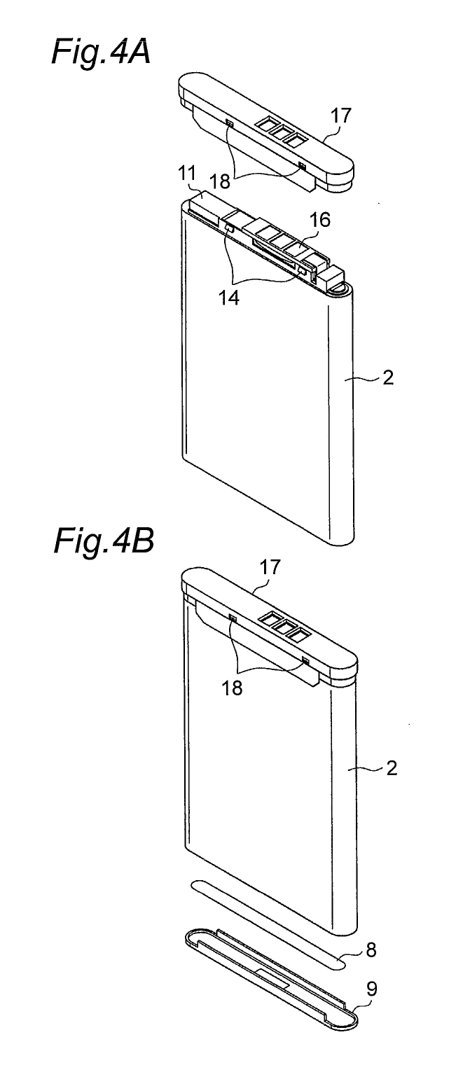

FIG. 4A is a perspective view of a state immediately before mounting of the exterior cover 17. In the state of FIG. 4A, the holes 18 of the exterior cover 17 and the fixing claws 14 of the frame 11 are engaged together, respectively, by which the exterior cover 17 is fixed to the frame 11. In addition, in FIG. 4A, the holes 18 of the exterior cover 17 and the fixing claws 14 of the frame 11 are provided at shallower and deeper sites in the depthwise direction of the battery pack 1. FIG. 4B is a perspective view of a state in which the exterior cover 17 has been mounted. Besides, the case bottom cover 9 is mounted via double-sided tape 8.

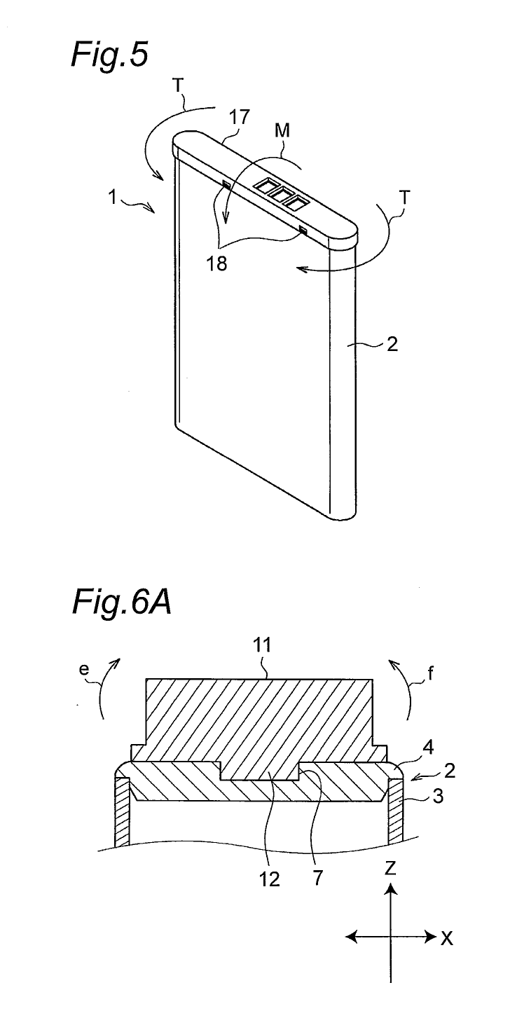

FIG. 5 shows a state that the label 19 (see FIG. 1) is stuck all around the unit cell 2, the battery pack 1 having been completed. In the state of FIG. 5, the various accessory parts shown in FIG. 1 are housed in the exterior cover 17. It is noted that the label 19 is formed from an insulative material to ensure electrical insulation between side faces of the unit cell 2 (exterior case 3) and outside of the battery pack 1.

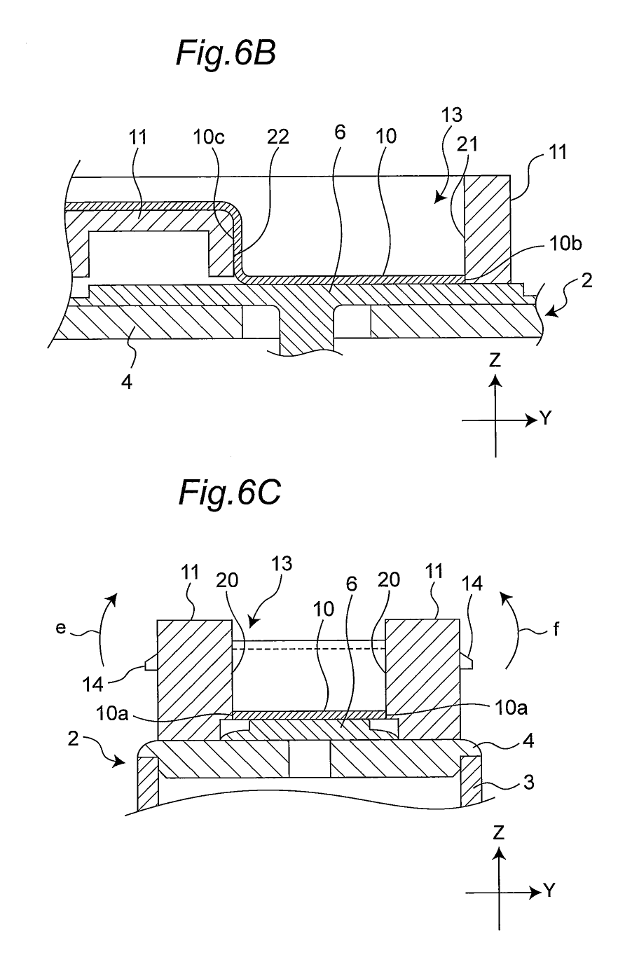

FIG. 6A is a sectional view of the battery pack 1 taken along the line A-A of FIG. 3B. As shown in FIG. 6A, the opening portion of the exterior case 3 of the unit cell is sealed by the sealing member 4. The protruding portion 12 formed in the frame 11 is engaged with the engaging hole 7 formed in the sealing member 4.

As a result of this, as viewed in FIG. 3B, one side (i.e., left side in the Y direction in the figure) of the frame 11 on which the protruding portion 12 is formed is inhibited from positional movement in thicknesswise direction (X direction) and widthwise direction (Y direction) of the unit cell 2 (i.e., movement along the mounting surface), and resultantly inhibited from movement in the rotational direction shown by arrow a.

FIG. 6B is a sectional view of the battery pack 1 taken along the line C-C of FIG. 3B. FIG. 6C is a sectional view of the battery pack 1 taken along the line B-B of FIG. 3B. The lead 10 is inserted through the opening 13 of the frame 11 as shown in FIG. 3B, and individual widthwise end faces 10a of the lead 10 are put into contact with inner peripheral surfaces (first inner peripheral surfaces) 20 that are mutually opposed in the X direction within the opening 13 as shown in FIG. 6C. As a result of this, the frame 11 is set into such a state as to be engaged with the lead 10 in the X direction.

Also, as shown in FIG. 6B, individual lengthwise end faces 10b of the lead 10 are put into contact with inner peripheral surfaces (second inner peripheral surfaces) 21 on the right side in the Y direction as in the figure within the opening 13. Further, the lead 10, as it is bent, has one end bonded to the protective circuit 16 fixed to the unit cell 2 via the protective element 15. In this bent state, as shown in FIG. 6B, part of a rear face 10c of the lead 10 is in contact with an inner peripheral surface (second inner peripheral surface) 22 on the left side in the Y direction as in the figure, within the opening 13. As a result of this, the frame 11 is set into such a state as to be engaged with the lead 10 in the Y direction. In this Embodiment 1, each of the inner peripheral surfaces 20, 21 and 22 in the opening 13 of the frame 11 is an example of the engagement portion.

As described before, one end of the lead 10 is welded to the positive terminal 6 by welding, while one side of the frame 11 in which the lead 10 is engaged is inhibited from positional movement in the thicknesswise direction (X direction) and widthwise direction (Y direction) of the unit cell 2, and resultantly inhibited from movement in the rotational direction shown by arrow b of FIG. 3A.

Also as shown in FIG. 3B, one end of the lead 10 is bonded to the upper side of the protective circuit 16. As a result of this, on the one side of the frame 11 on which the lead 10 is engaged is inhibited from positional movement in the heightwise direction (Z direction) of the unit cell 2. Further, pressing fitting of the protruding portion 12 into the engaging hole 7, if applied in FIG. 6A, makes advantage for prevention of positional movement in the heightwise direction (Z direction) also on the side of the frame 11 in which the protruding portion 12 is formed. In this case, the frame 11 is advantageous for prevention of positional movement in directions shown by arrows e, f in FIG. 6A.

In the completed-product state of the battery pack 1, as shown in FIG. 5, the exterior cover 17 is fitted to the upper part of the unit cell 2. More specifically, the frame 11 is accommodated in the exterior cover 17, and the exterior cover 17 is fitted to the frame 11. Therefore, when an external force causes a torsion, i.e. twist T or bend M, to act on the exterior cover 17, the force acts so that the exterior cover 17 is separated from the unit cell 2. In this case, the frame 11 fixed to the exterior cover 17 tends to be integrally displaced.

Meanwhile, as described before, the frame 11 is inhibited from movement in rotational directions shown by arrows a, b in FIG. 3B. Due to this, even if the twist T shown in FIG. 5 acts on the exterior cover 17, displacement of the exterior cover 17 is inhibited.

Next, referring to FIG. 5, when the bend M acts on the exterior cover 17, a force that causes the exterior cover 17 to be floated from the top portion of the unit cell 2 acts on the exterior cover 17. In this case, the frame 11 fixed to the exterior cover 17 tends to be integrally displaced.

Meanwhile, as described before, the one-side portion of the frame 11 in which the lead 10 is engaged is inhibited from movement in the heightwise direction (Z direction) of the unit cell 2. In FIG. 6A, pressing fitting of the protruding portion 12 into the engaging hole 7, if applied in FIG. 6A, makes advantage for prevention of positional movement in the directions shown by arrows e, f on the side of the frame 11 in which the protruding portion 12 is formed. Due to this, even if the bend M shown in FIG. 5 acts on the exterior cover 17, displacement of the exterior cover 17 is inhibited.

Accordingly, with the structure of this Embodiment 1, even if the twist T or bend M acts on the exterior cover 17, displacement of the exterior cover 17 is inhibited, making it possible to secure the reliability of the mechanical strength of the exterior part. Also, there is no need for adding any exclusive component parts for securement of the mechanical strength. Thus, no increases in parts counts or production man-hours are involved, so that cost increases can be suppressed.

Further, structural parts for fitting of the frame 11 and the exterior cover 17 to the mounting surface of the unit cell 2 are all placed on the mounting surface side, and not on the side faces of the unit cell 2 (exterior case 3). Accordingly, the unit cell 2 can be improved in its mechanical strength without causing any increase in the thickness of the unit cell 2, which is provided as a thinned one. Besides, since no pits or projections or the like are formed on the side faces of the unit cell 2, the label 19 can be easily and securely stuck to the side faces of the unit cell 2.

Although this Embodiment 1 shows an example in which the protruding portion 12 of the frame 11 and the engaging hole 7 of the unit cell 2 are engaged together at one place, yet it is also possible that the engagement portion is provided at some plural places, so that the mechanical strength of the exterior part can be further improved.

Also, instead of the case in which the protruding portion 12 is formed in the frame 11 while the engaging hole 7 is formed in the unit cell 2, it is also possible that the engaging hole is formed in the frame 11 while the protruding portion is formed in the unit cell 2.

The engaging hole 7 and the protruding portion 12 may be provided in various outer shapes such as circular, polygonal and elliptical shapes. Particularly when a polygonal shape or elliptical shape is selected, positioning of the frame 11 relative to the unit cell 2 becomes more easily achievable.

### Second Embodiment

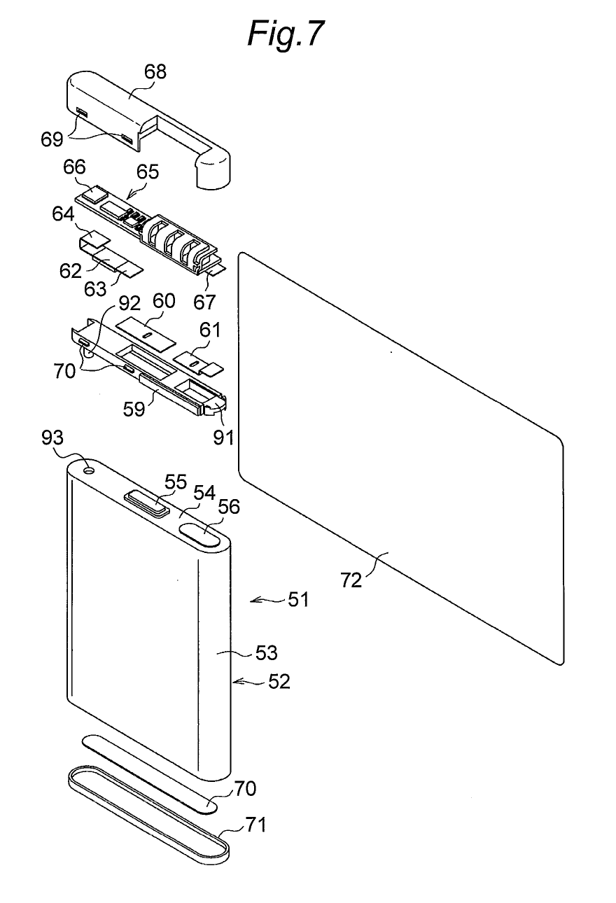

The present invention is not limited to the above-described Embodiment 1, and may be embodied in other various ways. FIG. 7 is an exploded perspective view of a battery pack 51 according to Embodiment 2 of the invention. FIG. 7 shows a unit cell 52 and various accessory parts to be fitted thereto. The battery pack 51, which is, for example, a rectangular-shaped lithium ion battery like the unit cell 2 of Embodiment 1, has a thinned flat quadrilateral shape whose depth is smaller in comparison to its longitudinal height and lateral length.

An opening portion of an exterior case 53 is sealed by a sealing member 54. The sealing member 54 is provided with a negative terminal 55 and a positive terminal 56.

A negative lead 60 is bonded to the negative terminal 55 by welding, while a positive lead 61 is bonded to the positive terminal 56 by welding. A one-end terminal 63 of a protective element 62 is bonded to the negative lead 60 by welding. Also, the negative lead 60 and the positive lead 61 are formed as strip-shaped members.

The other-end terminal 64 of the protective element 62 is bonded to a terminal 66 of a substrate-like protective circuit 65 by welding. A lead 67 of the protective circuit 65 is bonded to the positive lead 61 by welding.

Holes 69 of an exterior cover 68 (exterior member), which is a resin molded article, and fixing claws of the frame 59 are engaged with each other, respectively, by which the exterior cover 68 is fixed to the frame 59. A case bottom cover 71 is fitted to a lower part of the unit cell 52 via double-sided tape 70. A label 72 is stuck all around the unit cell 52.

As will be described in detail later, in a state that the frame 59 is fitted to the sealing member 54, a protruding portion 92 formed in the frame 59 is engaged with an engaging hole 93 formed in the sealing member 54 while the negative lead 60 and the positive lead 61 are engaged with the frame 59.

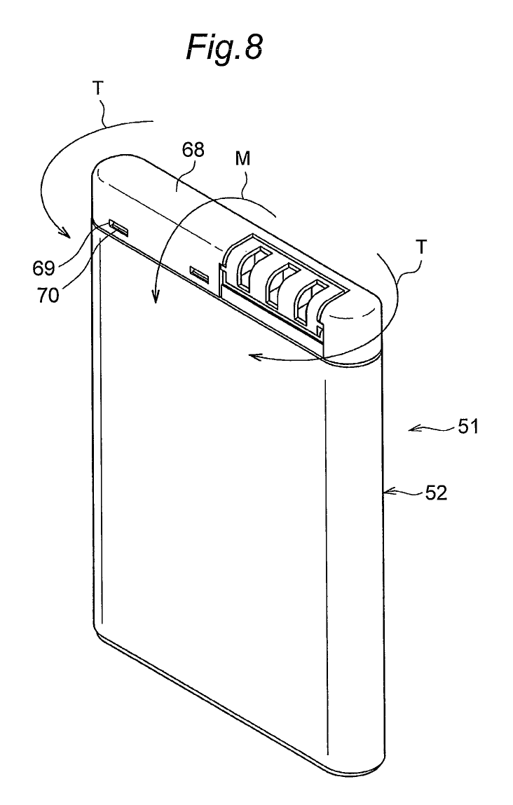

FIG. 8 is a perspective view of the completely assembled battery pack 51. In the state of FIG. 8, the various accessory parts shown in FIG. 7 are accommodated in the exterior cover 68.

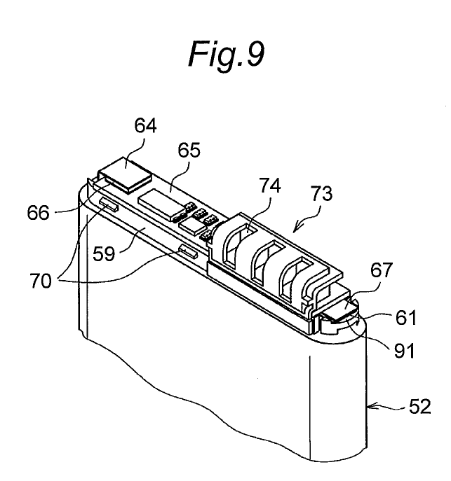

FIG. 9 is an enlarged view of an upper part of the unit cell 52 before setting of the exterior cover 68 in FIG. 7. The frame 59 supports the protective circuit 65. Various types of electrical equipment are mounted on the protective circuit 65. Further, a connector 73 is mounted on the protective circuit 65. The connector 73 has openings 74 formed therein, where external-connection use terminals are to be fitted at positions of the openings 74. In this Embodiment 2, the frame 59, the protective circuit 65, the connector 73, the external-connection use terminals, the leads and the like are included in the accessory parts.

The other-end terminal 64 of the protective element 62 (FIG. 7) is bonded to the terminal 66 of the protective circuit 65 by welding. the positive lead 61 is bonded to the lead 67 of the protective circuit 65 by welding.

Electrical connections are completed in the state of FIG. 9. In this state, fitting the exterior cover 68 shown in FIG. 7 to the frame 59 results in the state shown in FIG. 8. The holes 69 of the exterior cover 68 and the fixing claws 70 of the frame 59 are engaged with each other, respectively, by which the exterior cover 68 is fixed to the frame 59.

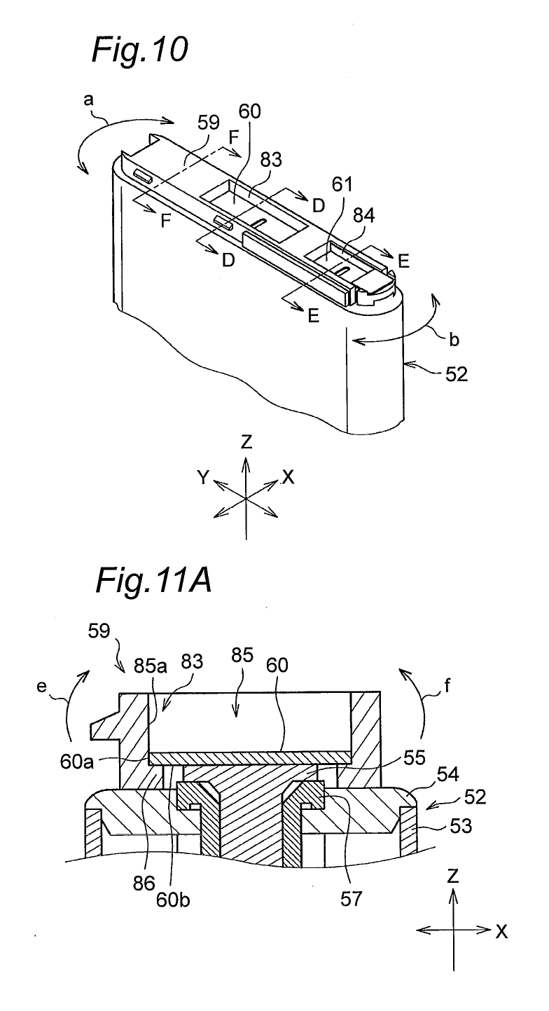

FIG. 10 is a perspective view showing a state that the negative lead 60 and the positive lead 61 are welded to the unit cell in FIG. 7. The negative lead 60 is engaged with an engagement portion 83 formed in the frame 59. Similarly, the positive lead 61 is engaged with an engagement portion 84.

In the state of FIG. 10, the negative lead 60 is bonded to the negative terminal 55 (FIG. 7) of the unit cell 52 by welding, and the positive lead 61 is bonded to the positive terminal 56 (FIG. 7) of the unit cell 52 by welding. Therefore, the negative lead 60 and the positive lead 61 are positionally moved in neither the thicknesswise direction (X direction) nor the widthwise direction (Y direction) nor the heightwise direction (Z direction) of the unit cell 52. It is noted that in this Embodiment 2, the X direction is the widthwise direction of the negative lead 60 and the positive lead 61, which are second sealing members, the Y direction is their longitudinal direction, and the Z direction is their thicknesswise direction.

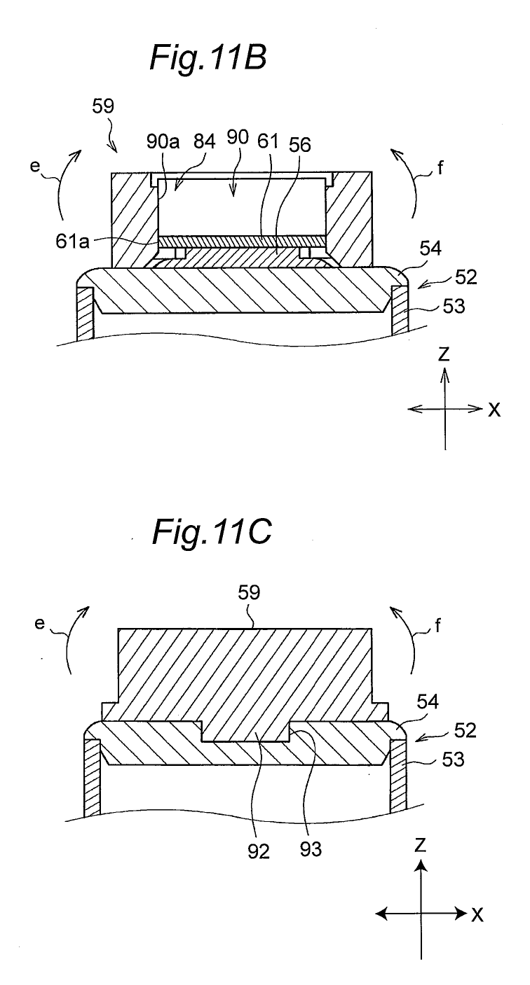

FIG. 11A is a sectional view taken along the line D-D of FIG. 10. An opening portion of the exterior case 53 is sealed by the sealing member 54. The sealing member 54 (i.e. mounting surface) has a negative terminal 65 fitted thereto via an insulator 57. An opening 85 is formed in the engagement portion 83 of the frame 59, and individual widthwise end faces 60a of the negative lead 60 are put into contact with inner peripheral surfaces 85a (first inner peripheral surfaces) that are opposed to the X direction within the opening 85. As a result of this, the frame 59 is set into such a state as to be engaged with the lead 60 in the X direction.

As described before, the negative lead 60, which is bonded to the negative terminal 55 by welding, is never positionally moved in the X direction, Y direction or Z direction shown in FIG. 10. As a result of this, when external force acts on the frame 59 engaged with the negative lead 60, the frame 59 is inhibited from positional movement in the X direction. Further, its movement in rotational directions shown by arrows a, b in FIG. 10 is also inhibited.

Also, a longitudinal end face of the negative lead 60 is in contact with individual inner peripheral surfaces (second inner peripheral surfaces) opposed to the Y direction as well as the individual inner peripheral surfaces 85a opposed to the X direction in the opening 85. As a result of this, the frame 59 is set into such a state as to be further engaged with the negative lead 60 in the Y direction. Therefore, when external force acts on the frame 59 engaged with the negative lead 60, the frame 59 is inhibited from positional movement in the Y direction. Further, its movement in the rotational directions shown by arrows a, b in FIG. 10 can also be inhibited more effectively.

A protruding portion 86 is protruded inwardly from the inner peripheral surface 85a of the opening 85. A one-side surface 60b (i.e., a surface 60b on the unit cell side) of the negative lead 60 is in contact with the protruding portion 86. As a result of this, the frame 59 is set into such a state as to be engaged with the lead 60 in the X direction. Therefore, when external force acts on the frame 59, the frame 59 is inhibited from positional movement in the Z direction. Further, its movement in rotational directions shown by arrows e, f in FIG. 11A is also inhibited.

For fulfillment of the engagement in the Z direction between the protruding portions 86 of the opening as shown in FIG. 11A and the negative lead 60, preferably, the negative lead 60 is so formed that the width in the X direction of the negative lead 60 becomes larger than the size in the same direction of the negative terminal 55. By forming the negative lead 60 and the negative terminal 55 in this way, both-end edges of the negative lead 60 can be protruded from the negative terminal 55 outward of the X direction at bonding portions by their welding, so that those protruded both-end edges can be engaged with the protruding portions 86 of the opening 85. Also, since the protruding portions 86 of the frame 59 having insulating property are placed interveniently between both-end edges of the protruding negative lead 60 and the sealing member 54 formed from a metal material, the negative lead 60 can reliably be prevented from making contact with the sealing member 54.

FIG. 11B is a sectional view taken along the line E-E of FIG. 10. The positive terminal 56 is bonded to the sealing member 54 by welding. An opening 90 is formed in the engagement portion 84 of the frame 59, and individual widthwise end faces 61a of the positive lead 61 are put into contact with inner peripheral surfaces 90a (first inner peripheral surfaces) that are opposed to the X direction within the opening 90. As a result of this, the frame 59 is set into such a state as to be engaged with the positive lead 61 in the X direction.

As described before, the positive lead 61, which is bonded to the positive terminal 56 by welding, is never positionally moved in the X direction, Y direction or Z direction shown in FIG. 10. As a result of this, when external force acts on the frame 59 engaged with the positive lead 61, the frame 59 is inhibited from positional movement in the X direction. Further, its movement in the rotational directions shown by arrows a, b in FIG. 10 is also inhibited.

Also, a longitudinal end face of the positive lead 61 is in contact with individual inner peripheral surfaces 90 (second inner peripheral surfaces) opposed to the Y direction as well as the individual inner peripheral surfaces 90 opposed to the X direction in the opening 90. As a result of this, the frame 59 is set into such a state as to be further engaged with the positive lead 61 in the Y direction. Therefore, when external force acts on the frame 59 engaged with the positive lead 61, the frame 59 is inhibited from positional movement in the Y direction. Further, its movement in the rotational directions shown by arrows a, b in FIG. 10 can also be inhibited more effectively.

Further, the engagement portion 84 includes a restricting surface 91 shown in FIG. 7 as well. The restricting surface 91 is a flat portion serving as a seat for part of the positive lead 61. As shown in FIGS. 9 and 10 or the like, a one-side end portion of the positive lead placed through the opening 90 is bent stepwise while this end portion of the positive lead 61 is superposed on the restricting surface 91 formed in part of upper-surface side peripheral edges of the opening 90. As a result of this, the end portion of the positive lead 61 and the restricting surface 91 are engaged with each other in the Z direction. Thus, when external force acts on the frame 59, the frame 59 is inhibited from positional movement in the Z direction. Further, its movement in the rotational directions shown by arrows e, f of FIG. 11B is also inhibited.

In particular, as shown in FIG. 11B, in a case where the width in the X direction of the positive lead 61 cannot be set larger than the width in the same direction of the positive terminal, using such a restricting surface 91 makes it possible to achieve reliable engagement between the frame 59 and the positive lead 61 in the Z direction.

Also, as shown in FIG. 9, with the positive lead 61 placed on the restricting surface 91, making the lead 67 superposed on the positive lead 61 makes it easily achievable to bond superposing place between the lead 67 and the positive lead 61 by spot welding. During the spot welding, the restricting surface 91 can function as a seat for receiving the two leads 61, 67.

In FIG. 11B, no shape corresponding to the protruding portion 86 of FIG. 11A is provided in the inner peripheral surfaces 90a. However, the specifications may include provision of such a shape.

Also, this Embodiment 2 adopts a structure in which the frame 59 is engaged with the negative lead 60 and the positive lead 61 welded to the negative terminal 55 and the positive terminal 56 of the unit cell 2, so that the frame 59 is fixed. From such a point of view, desirably, the material, thickness and the like of the negative lead 60 and the positive lead 61 are so set that necessary rigidity can be ensured. For example, when nickel is used as a lead material, its thickness is preferably increased to about 0.15 mm to 0.3 mm, thicker than conventional ones.

Next, FIG. 11C is a sectional view taken along the line F-F of FIG. 10. An engaging hole 93 is formed in an upper surface (mounting surface) of the sealing member 54, while a protruding portion 92 to be engaged with this engaging hole 93 is formed in a lower surface of the frame as viewed in the figure. By such engagement of the engaging hole 93 and the protruding portion 92 with each other, the frame 59 is set into such a state as to be engaged with the unit cell 2 in directions along the mounting surface, i.e., the X direction and the Y direction.

As a result of this, when external force acts on the frame 59, the frame 59 is inhibited from positional movement in the X direction and the Y direction. Therefore, its movement in the rotational directions shown by arrows a, b in FIG. 10 is also inhibited. Further, in a case where the outer size of the protruding portion 92 of the frame 59 is set slightly larger than the inner diameter of the engaging hole 93 of the sealing member 54 so that the protruding portion 92 is press fitted into the engaging hole 93, the frame 59 can also be engaged also in the Z direction for the unit cell 52. It is also possible that the engaging hole is formed in the frame 59 while the protruding portion is formed in the sealing member 54.

In the completed-product state of the battery pack 51, as shown in FIG. 8, the exterior cover 68 is fitted to the upper part of the unit cell 52. In more detail, the frame 59 is accommodated in the exterior cover 68, and the exterior cover 68 is fitted to the frame 59. Therefore, when an external force causes a torsion, i.e. twist T or bend M, to act on the exterior cover 68, the force acts so that the exterior cover 68 is separated from the unit cell 52. In this case, the frame 59 fixed to the exterior cover 68 tends to be integrally displaced.

Meanwhile, as described before, the frame 59 is inhibited from movement in the rotational directions shown by arrows a, b of FIG. 10. Due to this, even if the twist T shown in FIG. 8 acts on the exterior cover 68, displacement of the exterior cover 68 is inhibited.

Next, referring to FIG. 8, when the bend M acts on the exterior cover 68, a force that causes the exterior cover 68 to be floated from the top portion of the unit cell 52 acts on the exterior cover 68. In this case, the frame 59 fixed to the exterior cover 68 tends to be integrally displaced.

Meanwhile, as described before, the frame 59 is inhibited from movement in the rotational directions shown by arrows e, f of FIGS. 11A, 11B and 11C. Due to this, even if the bend M shown in FIG. 8 acts on the exterior cover 68, displacement of the exterior cover 68 is inhibited.

Accordingly, with the structure of this Embodiment 2, even if the twist T or bend M acts on the exterior cover 68, displacement of the exterior cover 68 is inhibited, making it possible to secure the reliability of the mechanical strength of the exterior part. Also, there is no need for adding any exclusive component parts for securement of the mechanical strength. Thus, no increases in parts counts or production man-hours are involved, so that cost increases can be suppressed.

Further, also for the unit cell 52, there is no need for adding processes or exclusive component parts, and the unit cell 52 may be designed for commonization with other device models. This is also advantageous in terms of cost.

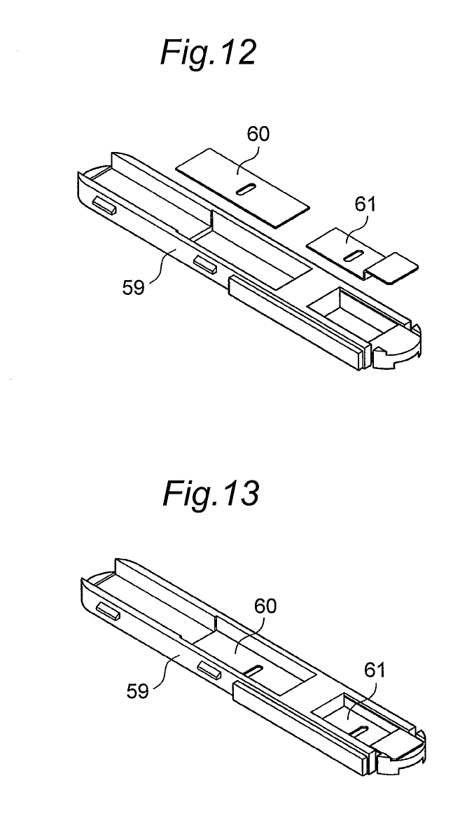

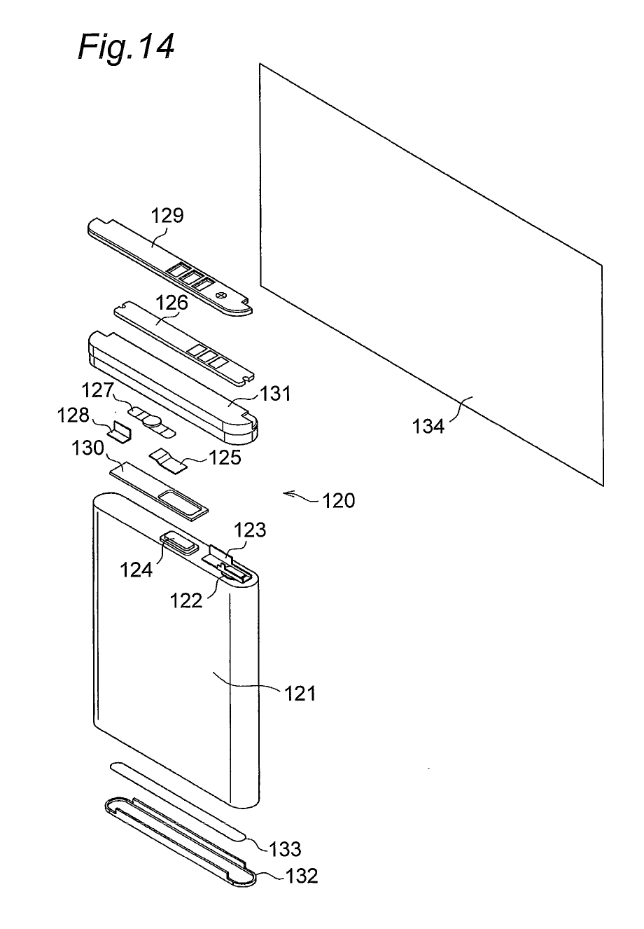

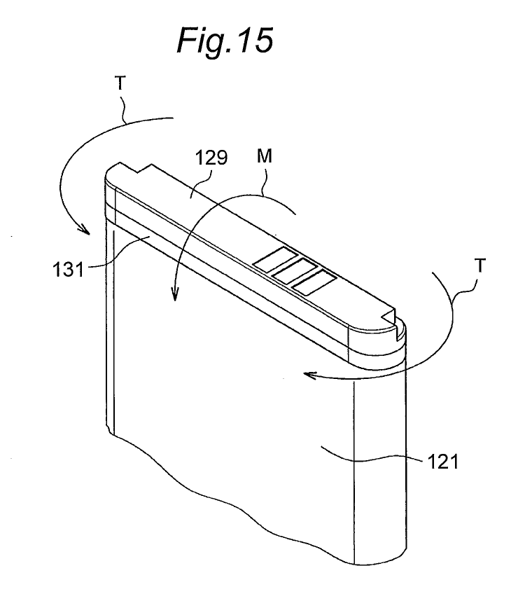

FIG. 12 is a perspective view showing the frame 59, the negative lead 60 and the positive lead 61. The frame 59, the negative lead 60 and the positive lead 61 can be treated as individual separate component parts, respectively, in the state of FIG. 12. In this case, in the example of FIG. 7, after the frame 59 is fitted to the sealing member 54 while the protruding portion 92 is engaged with the engaging hole 93, the negative lead 60 and the positive lead 61 are engaged with the engagement portions 83, 84 of the frame 59 as shown in FIG. 10.

More specifically, the protruding portion 92 of the frame 59 is engaged with the engaging hole 93 of the sealing member 54 and moreover, in order that the negative terminal 55 and the positive terminal 56 of the sealing member 54 are located within the opening 85, 90 of the frame 59, the frame 59 is positioned relative to the sealing member 54 and so fitted to the sealing member 54 with the double-sided tape 58. Thereafter, the negative lead 60 and the positive lead 61 are so placed as to be fitted into the opening 85, 90 of the frame 59, by which the negative lead 60 and the positive lead 61 can be set in a proper place relative to the negative terminal 55 and the positive terminal 56. In this state, performing spot welding from the upper surface side of the negative lead 60 and the positive lead 61 allows the negative lead 60 to be bonded to the negative terminal 55 and moreover the positive lead 61 to be bonded to the positive terminal 56, so that the frame 59 can securely be engaged with those leads 60, 61. Accordingly, assembling work of the battery pack 51 can be achieved more efficiently, so that the productivity can also be improved.

Meanwhile, the negative lead 60 and the positive lead 61 may be integrated to the frame 59 in advance. Such integration is suitably achieved by insert molding.

FIG. 13 is a perspective view showing the insert-molded frame 59. The negative lead 60 and the positive lead 61 are bonded to the frame 59 of FIG. 13 by insert molding. More specifically, with the negative lead 60 and the positive lead 61 inserted in a mold in advance, resin is injected into the mold, by which a molded article of the frame 59 and the negative lead 60 and the positive lead 61 that have been integrated together can be obtained.

With use of the frame 59 shown in FIG. 13, a step for making the negative lead 60 and the positive lead 61 engaged with the frame 59 can be omitted in the battery pack assembling process.

In addition, in Embodiment 1 and 2, for the fitting of the resin-made frame to the sealing member, for example, the frame may be temporarily bonded to the sealing member via double-sided tape.

Also, although Embodiment 1 shows an example having one place where the lead engaged with the frame is bonded to the unit cell while Embodiment 2 shows an example having two such places, yet it is also allowable to provide three or more such welding places.

Also, although Embodiment 1 and 2 have been described on a constitution that the frame is fixed to the unit cell by engagement between protruding portion and engaging hole as well as engagement between frame and lead, yet the frame may be fixed to the unit cell only by engagement places between protruding portion and engaging hole.

In many cases, an injection hole for injection of an electrolyte material into the exterior case is formed in the sealing member of the unit cell. This injection hole may be made to serve also as an engaging hole and so designed as to be engaged with the protruding portion of the frame.

Also, although Embodiment 1 and 2 have been described on an example in which the frame is fixed to the unit cell and the exterior cover is fitted to the frame, yet it is also possible that the protruding portion is formed in the exterior cover so as to be engaged with the engaging hole formed in the mounting surface of the unit cell. With this constitution, it is further possible that the exterior cover and the frame are engaged with each other while the lead and the frame are engaged with each other.

As described hereinabove, according to the battery pack of the present invention, high reliability of mechanical strength of the exterior part can be ensured with a simple structure. Thus, the battery pack according to the invention is useful as battery packs for use in, for example, mobile phones and mobile equipment. Besides, since the structure for fitting the exterior part to the unit cell can be integrated only to the mounting surface of the unit cell, the battery pack can be provided thinner in thickness. Thus, the battery pack according to the invention is useful as battery packs having a thinned flat quadrilateral shape.

It is to be noted that, by properly combining the arbitrary embodiments of the aforementioned various embodiments, the effects possessed by them can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2009-103233 filed on Apr. 21, 2009, including specification, claims, and drawings are incorporated herein by reference in its entirety.

What is claimed is:

1. A battery pack comprising:
a unit cell having a mounting surface on which a terminal portion is formed;
accessory parts for extracting electricity from the terminal portion of the unit cell to outside of the battery pack; and
an exterior member which covers the mounting surface of the unit cell and the accessory parts, wherein
the accessory parts include a frame for holding the exterior member, and
either one of an engaging hole and a protruding portion, which are to be engaged with each other, is formed on the mounting surface of the unit cell while the other of the engaging hole and the protruding portion is formed in the frame, so that the frame is fixed to the mounting surface at least in a direction along the mounting surface of the unit cell.

2. The battery pack as defined in claim 1, wherein the accessory parts include a protective circuit, and a strip-shaped electrical-connection use lead which is connected to the terminal portion of the unit cell by welding so that the terminal portion and the protective circuit are electrically connected to each other, and
an engagement portion to be engaged with the lead is formed in the frame.

3. The battery pack as defined in claim 2, wherein an opening through which the lead is set is formed in the frame, and with mutually opposed first inner peripheral surfaces of the opening of the frame serving as said engagement portion, widthwise both end faces of the strip-shaped lead are set into contact with the first inner peripheral surfaces, whereby the frame is engaged with the lead in a widthwise direction of the lead.

4. The battery pack as defined in claim 3, wherein second inner peripheral surface crossing with the first inner peripheral surfaces of the opening of the frame is used as further said engagement portion, and longitudinal end face of the strip-shaped lead is set into contact with the second inner peripheral surface, whereby the frame is engaged with the lead in the longitudinal direction of the lead.

5. The battery pack as defined in claim 4, wherein protruding portions inwardly protruded from the mutually opposed first inner peripheral surfaces of the opening of the frame are formed as further said engagement portion, and a unit cell-side surface of the strip-shaped lead is set into contact with the protruding portions, whereby the frame is engaged with the lead in a thicknesswise direction of the lead.

6. The battery pack as defined in claim 5, wherein at welding-connecting portions between the lead and the unit cell, the unit cell-side surface of the lead, formed so as to have a larger size in a widthwise direction of the strip-shaped lead than the terminal portion of the unit cell and protruded in the widthwise direction from the terminal portion, is engaged with the protruding portions.

7. The battery pack as defined in claim 5, wherein the unit cell has a flat quadrilateral shape whose depth is smaller in comparison to its longitudinal height and lateral length, and exterior members and accessory parts are mounted on the mounting surface which is given by a longitudinal end face of the unit cell, where the widthwise direction of the strip-shaped lead corresponds to a depthwise direction of the unit cell and the thicknesswise direction of the lead corresponds to a longitudinal direction of the unit cell.

8. The battery pack as defined in claim 7, wherein the terminal portion is provided at one of lateral both end portions of the mounting surface of the unit cell, and the engaging hole or the protruding portion is provided in the other one of the end portions.

9. The battery pack as defined in claim 1, wherein the protruding portion is press fitted into the engaging hole.

10. The battery pack as defined in claim 1, wherein the engaging hole and the protruding portion to be engaged with each other are provided in a plurality of sets.

11. A battery pack comprising:
a unit cell having a mounting surface on which a terminal portion is formed;
accessory parts for extracting electricity from the terminal portion of the unit cell to outside of the battery pack; and
an exterior member which covers the mounting surface of the unit cell and the accessory parts, wherein
either one of an engaging hole and a protruding portion, which are to be engaged with each other, is formed on the mounting surface of the unit cell while the other of the engaging hole and the protruding portion is formed in the exterior member, so that the exterior member is fixed to the mounting surface at least in a direction along the mounting surface of the unit cell.

12. The battery pack as defined in claim 11, wherein the accessory parts include a frame for holding the exterior member, a protective circuit, and a strip-shaped electrical-connection use lead which is connected to the terminal portion of the unit cell by welding so that the terminal portion and the protective circuit are electrically connected to each other, and
an engagement portion to be engaged with the lead is formed in the frame.

13. A battery pack manufacturing method comprising:
making an engaging hole and a protruding portion engaged with each other to fulfill positioning of a frame relative to a mounting surface of a unit cell in which at least one of the engaging hole and the protruding portion is formed, the frame having the other of the engaging hole and the protruding portion formed therein, as well as to fulfill positioning of a terminal portion formed in the mounting surface within an opening of the frame;
setting a strip-shaped electrical-connection use lead so that inner peripheral surfaces of the opening of the frame and widthwise end faces of the lead are put into contact with each other, whereby the lead is placed on the terminal portion exposed from the opening;
welding the lead and the terminal portion together so that at an engagement place between the frame and the lead, the frame is fixed at least in a widthwise direction of the strip-shaped lead; and
thereafter fitting an exterior member to the frame so as to cover the terminal portion, the lead and the frame so that the exterior member is fixed to the mounting surface at least in a direction along the mounting surface.

14. The battery pack manufacturing method as defined in claim 13, wherein the lead is placed on the terminal portion exposed from the opening so that the inner peripheral surfaces of the opening of the frame and widthwise and longitudinal end faces of the strip-shaped lead are put into contact with each other, respectively, and the lead and the terminal portion are welded together, whereby the frame is fixed in the widthwise and longitudinal directions of the strip-shaped lead.

15. The battery pack manufacturing method as defined in claim 14, wherein the lead is placed on the terminal portion exposed from the opening so that the inner peripheral surfaces of the opening of the frame and widthwise and longitudinal end faces of the strip-shaped lead are put into contact with each other, respectively, while the protruding portion inwardly protruded from the inner peripheral surfaces of the opening of the frame and the unit cell-side surface of the lead are further put into contact with each other, and then the lead and the terminal portion are welded together, whereby the frame is fixed in the widthwise, longitudinal and thicknesswise directions of the strip-shaped lead.
